(19) United States
(12) Patent Application Publication
(10) Pub. No.: US 2021/0207972 A1
(43) Pub. Date: Jul. 8, 2021

(54) ARCHITECTURE RECOGNITION METHOD AND IDENTIFICATION SYSTEM

(71) Applicant: ANASTASIA SERGEYEVNA VANYUSHINA, MOSCOW (RU)

(72) Inventor: ANASTASIA SERGEYEVNA VANYUSHINA, MOSCOW (RU)

(21) Appl. No.: 16/736,999

(22) Filed: Jan. 8, 2020

(51) Int. Cl. G01C 21/36; H04W 4/024; G06F 3/0484; G06K 9/00; G01S 19/42

(52) U.S. Cl. CPC G01C 21/3623; H04W 4/024; G01S 19/42; G06K 9/00671; G06F 3/04842

(57) ABSTRACT

A method for recognizing and identifying a structure. A user aims an electronic device at a structure and an image of the structure is displayed. The user then traces over the displayed structure to create an outline of the structure. This outline data is transmitted to a cloud server and compared with data in a database stored on the cloud server. When a match is found, the structure is recognized and data about the identified structure is sent to the user's device. The data/information is displayed on the device and can be accessed by the user. The user's current location is used to eliminate structures from consideration. After identification GPS data is sent to the user's device along with the structure information. The location of the structure is indicated on an electronic map and navigation details are provided to travel to the structure from the current location.

### BACKGROUND OF THE INVENTION

### Field of the Invention

The present invention relates to augmented reality and object recognition systems. More specifically, the present invention discloses a method for recognizing and identifying a structure using an electronic device and an architectural database and provide information to a user about the structure and navigation instructions to the structure's location.

### Description of the Prior Art

Traditionally when sightseeing or studying, it is necessary to carry a guidebook with you. When a traveler encounters various landmarks they must scan through their guidebook hoping to find a photograph of the landmark where they are. However, due to size considerations, only a small number of photos can be included in the guidebook. Additionally, there is only one photograph from one angle of the landmark.

Not only is searching through photos time consuming, but the limited number of included photos restricts the amount of information the traveler can access.

Another traditional method involves using maps. As a traveler journeys around an area they must constantly refer to the map in order to confirm their location. Even if the landmark is noted on the map, the only information provided is the name of the landmark.

This continually looking at a landmark and then referencing a book or map to determine if you are at this particular landmark is very inefficient and reduces the enjoyment or reward of sightseeing.

Therefore, there is need for an efficient method and system for effectively recognizing and identifying a structure or landmark and receive historical or navigation information about the structure on a mobile user device.

### SUMMARY OF THE INVENTION

To achieve these and other advantages and in order to overcome the disadvantages of the conventional method in accordance with the purpose of the invention as embodied and broadly described herein, the present invention provides an efficient method for recognizing and identifying a structure such as a building, statue, or monument.

A user utilizes an electronic device such as, for example, a mobile telephone, a mobile camera, or a tablet computer. The user aims the electronic device at a structure and the structure is displayed on the electronic device's display.

The user then traces over the displayed structure image to create an outline or wire-frame of the structure. This outline data is transmitted to a cloud server and compared with data in a database stored on the cloud server. When a match is found, the structure is recognized and data/information about the identified structure is sent to the user's device. The data/information is displayed on the device and can be accessed by the user.

Since only the outline data and not the full photographic detail data is sent to the cloud server, the data exchange is minimized and network bandwidth is saved.

The data sent to the user's device comprises, for example, structure name, architect or designer name and information, historical and architectural details on the structure, different retrospective images and available information of the structure (such as photos, blueprints, drafts, sketches made many years ago, etc.), This allows for visualization of the building in a chosen century (how it looked in 19 or 16 century, for example).

This information also comprises 3D models of the interior and exterior of the buildings.

Using the augmented reality techniques, the present invention can look at the street, and the user can “time travel”. This can be done by choosing a century or an age (this can include a choice of a historical personage, like Gaudi or Napoleon).

Also, can look inside the building and take a virtual tour of the inside of the building even though physical entry isn't permitted or possible.

Furthermore, since the building has been identified, the contents of the building can be individually examined by users taking the virtual tour. For example, an art museum that has numerous items in their catalogue but not able to exhibit at the same time can be enjoyed even if the artwork is in storage.

The method further comprises determining and sending GPS, triangulation, or other position data related to the current location of the user to the cloud server along with the outline data. This assists in narrowing down or improving accuracy of the identification and recognition of the structure.

The method comprises calculating an absolute position of a GPS receiver of the user device and an absolute time of reception of satellite signals. The GPS receiver of the user devices calculates ranges that estimate the distance from the user device to a plurality of satellites in the GPS network.

If the recognition of the structure fails, the application or cloud server can request more data from the user. For example, data about individual elements such as columns illustrating Ionic or Doric columns, color pigmentation of walls (interior, exterior), window shape/size, roof shape, building construction materials (concrete, wood), etc.

In addition, if the building has a specific label (like a name or historical note), it can also be sent to the cloud server and used to recognise the building. This data can comprise typed text, optical code recognition results on the text of the label, or a photograph of the label or plaque.

The present invention also allows a user to aim their device at a structure that is in eyesight but far away from the user's current location. The outline data and user's position data are sent to the cloud server. When the server identifies the building, GPS data representing position or location of the structure is sent to the user's device along with the structure information. The location of the structure is indicated on an electronic map and navigation details are provide so the user can easily navigate to the structure from their current location.

Following is a brief scenario for application of the method.

The present invention provides an application to run on the user's device. This application is organized as an interactive real-time operation. The user points his mobile device at a building or structure. The camera attempts to draw an outline around the building. If the building is not recognised as a particular building, the user interactively draws an outline around or on the building displayed on the device. In addition, the user can select just some part of the building. Then the internal simple recognition algorithm tries to detect necessary building details to be sent to an architects portfolio cloud service. This shortens data transfers, especially for expensive mobile internet access. Nevertheless, the image fragment highlighted (automatically or by the user) is being kept in the camera memory, so it can additionally be sent to the cloud service for further reference.

The present invention can be implemented in numerous ways or applications. For example, Inform tourists about various established landmarks (ad based business model), educate students about specific architecture structures and construction technology (grant or publicly funded model), provide general information to general population about buildings and landmarks (government sponsored grant model), cost/value appraisals for investment professionals (subscription model), or risk analysis for insurance professionals (subscription model).

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification.

The drawings illustrate embodiments of the invention and, together with the description, serve to explain the principles of the invention. In the drawings:

FIG. 1A is a drawing illustrating a user device displaying a real-time image of a structure for a method for identifying a structure according to an embodiment of the present invention;

FIG. 1B is a drawing illustrating a user device displaying a real-time image of a structure for a method for identifying a structure and an outline of the structure according to an embodiment of the present invention;

FIG. 1C is a drawing illustrating a user device displaying an outline of the structure for a method for identifying a structure according to an embodiment of the present invention;

FIG. 2 is a drawing illustrating an architecture of a method for identifying a structure according to an embodiment of the present invention;

FIG. 3 is a flowchart illustrating a method for identifying a structure according to an embodiment of the present invention;

FIG. 4 is a flowchart illustrating a method for identifying a structure according to an embodiment of the present invention;

FIG. 5 is a flowchart illustrating a method for identifying a structure according to an embodiment of the present invention;

FIG. 6 is a flowchart illustrating a method for identifying a structure according to an embodiment of the present invention;

FIG. 7 is a flowchart illustrating a method for identifying a structure by a cloud server and providing appropriate location and navigation information to a user device according to an embodiment of the present invention;

FIG. 8 is a flowchart illustrating a method for identifying a structure by a user device and providing appropriate location and navigation information on the user device according to an embodiment of the present invention;

FIG. 9 is a drawing illustrating a user's current location, a structure's location, and routing information on an electronic map according to an embodiment of the present invention;

FIG. 10 is a drawing illustrating a user device displaying a real-time image of a structure for a method for identifying a structure, an outline of the structure utilizing template shapes according to an embodiment of the present invention; and

FIG. 11 is a drawing illustrating a user device displaying a menu comprising a plurality of the structure types according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

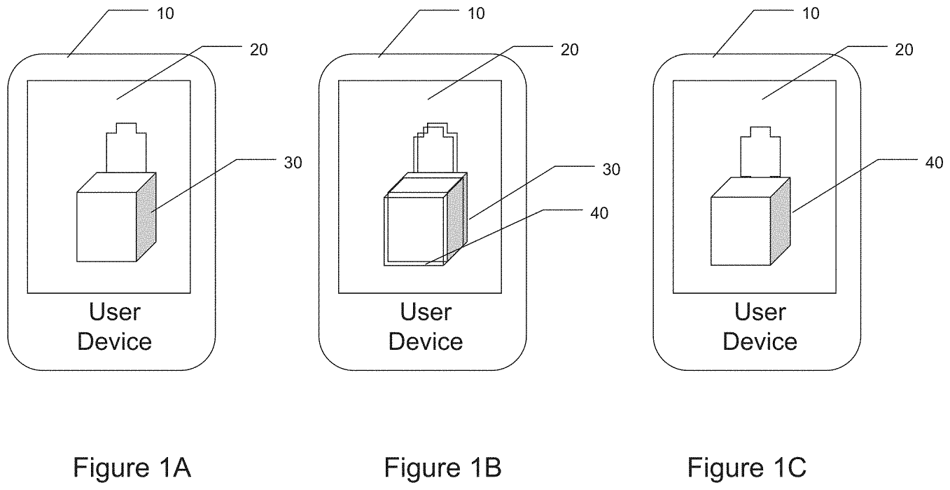

Refer to FIGS. 1A, 1B, and 1C which are drawings illustrating a user device displaying a real-time image of a structure and a user outline tracing for a method for identifying a structure according to an embodiment of the present invention.

A user device 10 is utilized to capture an image 30 of a structure and display the structure's image 30 in real-time on a display 20 that is integrated into the user device 10.

The user device 10 comprises, for example, a mobile telephone, a tablet computer, a digital camera, or other electronic device capable of capturing objects via a camera or lens and displaying the objects on an integrated display.

The structure comprises, for example, a building, a landmark, a monument, or a statue.

The user traces on the display 20 to make an outline 40 of the structure image 30. The outline 40 is captured and saved.

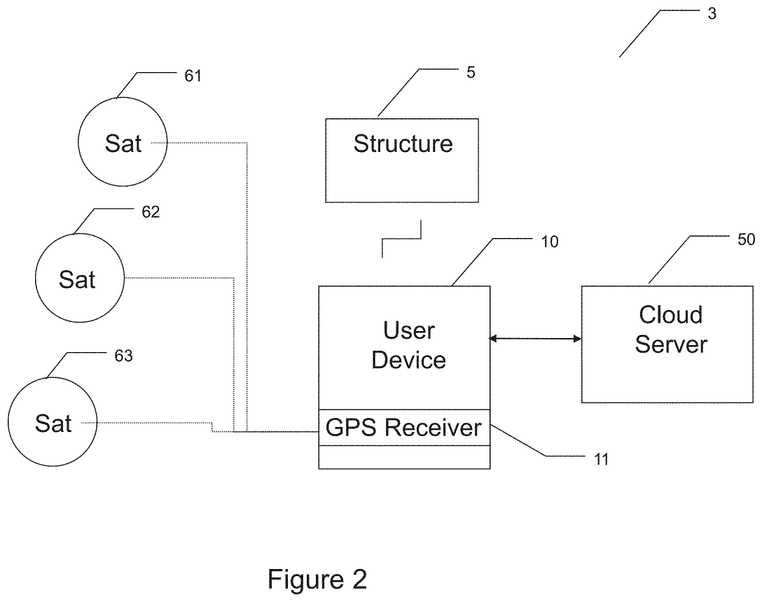

Also, refer to FIG. 2, which is a drawing illustrating an architecture 3 of a method for identifying a structure according to an embodiment of the present invention, while referring to FIG. 1A, !B, 1C.

Rather than utilize and transmit a complex photograph of the structure 5 that was captured by the user device 10, the user created outline 40 is sent to a cloud server 50. This greatly reduces the quantity of data transferred and the time required to transfer the data. This lowers costs and speeds up the process.

The cloud server 50 compares the outline 40 with data in a structure database. When a match is found, data and information about the structure 5 are sent from the cloud server 50 to the user device 10 and the information is displayed on the display 20 of the user device 10.

The user device 10 further comprises a GPS receiver 11. The present invention comprises calculating an absolute position of the GPS receiver 11 of the user device 10 and an absolute time of reception of satellite signals. The GPS receiver 11 of the user device 10 calculates ranges that estimate the distance from the user device 10 to a plurality of satellites 61,62,63 in the GPS network.

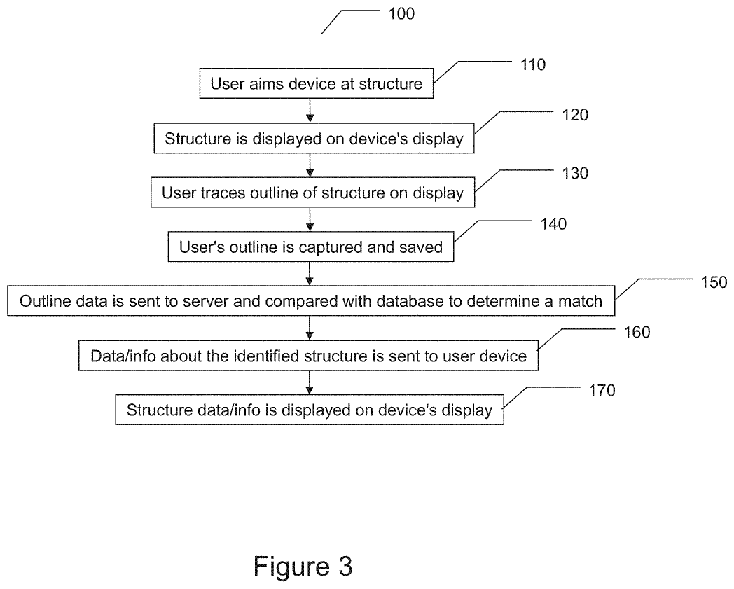

Refer to FIG. 3, which is a flowchart illustrating a method for identifying a structure according to an embodiment of the present invention.

The method 100 of the present invention begins by a user aiming their electronic user device at a structure in Step 110. In Step 120 an image of the structure is displayed on the user device's display.

Next, in Step 130, the user traces over the image of the structure to create an outline or wire-frame of the structure. The user traces on the display with their finger or an appropriate pen. The outline indicates, for example, the corners, the roof, the windows, the base, columns, the top, the exterior shape, or other identifying elements of the structure.

The user created outline is captured and stored on the user device in Step 140.

In Step 150 the user created outline data is sent to the cloud server and the cloud server utilizes a database of structure or architectural data to identify a structure matching the outline.

The cloud server sends data and information related to or associated with the identified structure to the user device in Step 160

In Step 170 the structure data and information is displayed on the display of the user device. The user is now able to interact with the information to learn more about the structure. This information is stored on the user device to enable the user to interact with the structure's information at any time even when not physically present near the structure.

In an embodiment of the present invention if the structure can not be accurately identified, the user will be prompted to provide additional data about the structure.

In an embodiment of the present invention the user created outlines are stored in the database and associated with the identified building and utilized in future comparisons.

In an embodiment of the present invention the user is prompted to confirm that the identified structure is correct. If not, further comparisons are performed.

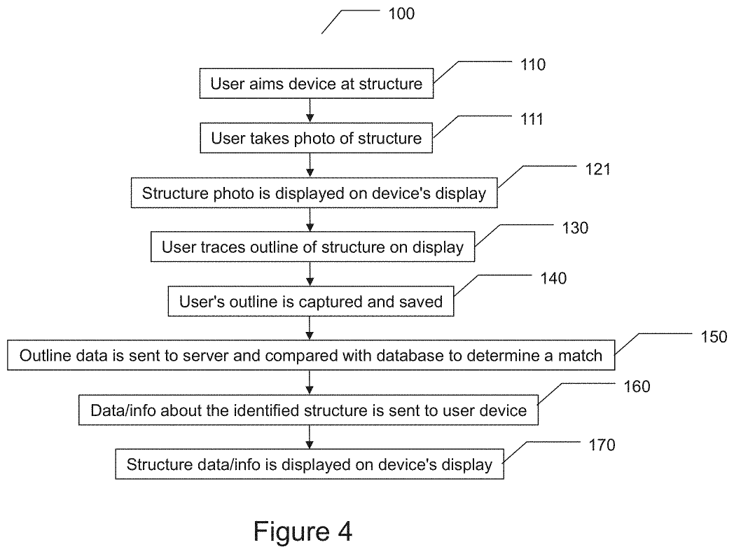

Refer to FIG. 4, which is a flowchart illustrating a method for identifying a structure according to an embodiment of the present invention.

In certain situations it is more effective to utilize a stable fixed image rather than a real-time image. For example, if the user is in a motor vehicle or moving in relation to the structure. In these situations the present invention provides the embodiment illustrated in FIG. 4.

The method 100 of the present invention begins by a user aiming their electronic user device at a structure in Step 110.

In Step 111 the user takes a photo of the structure using the user device.

The photograph of the structure is displayed on the user device's display in Step 121.

Next, in Step 130, the user traces over the image of the structure to create an outline or wire-frame of the structure. The user traces on the display with their finger or an appropriate pen. The outline indicates, for example, the corners, the roof, the windows, the base, columns, the top, the exterior shape, or other identifying elements of the structure.

Since the user is tracing over a still image of the structure, the accuracy of the traced outline can be improved thereby increasing the reliability of the identification of the structure. Also, the user device can be placed on a table to eliminate movement while the user is tracing.

In this embodiment the photograph is stored as well as the user created outline tracing.

The remaining Steps 140-170 are similar to the embodiment of FIG. 3.

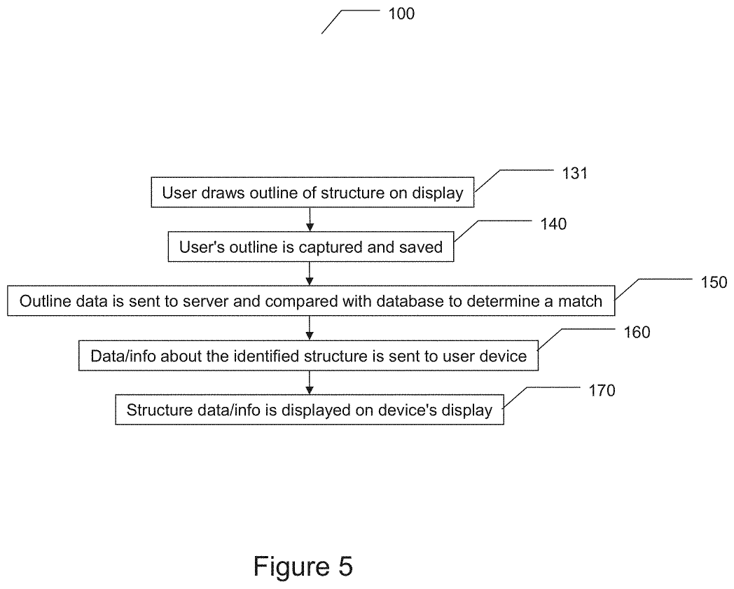

Refer to FIG. 5, which is a flowchart illustrating a method for identifying a structure according to an embodiment of the present invention.

In this embodiment an image of a structure is not provided or displayed on the user device.

The method 100 begins by the user drawing or sketching an outline of a structure on the display of the user device in Step 131.

For example, the user can create an outline of their own design or creation, or draw an outline from memory.

The remaining Steps 140-170 are similar to the embodiment of FIG. 3.

An advantage of this embodiment is the user does not have to be physically present at the structure's location,

Another advantage is a user who is designing a building can check to see if there are any similar structures.

Another advantage is an artist creating a sculpture can check to see if there are already similar sculptures in order to prevent duplication or overlap.

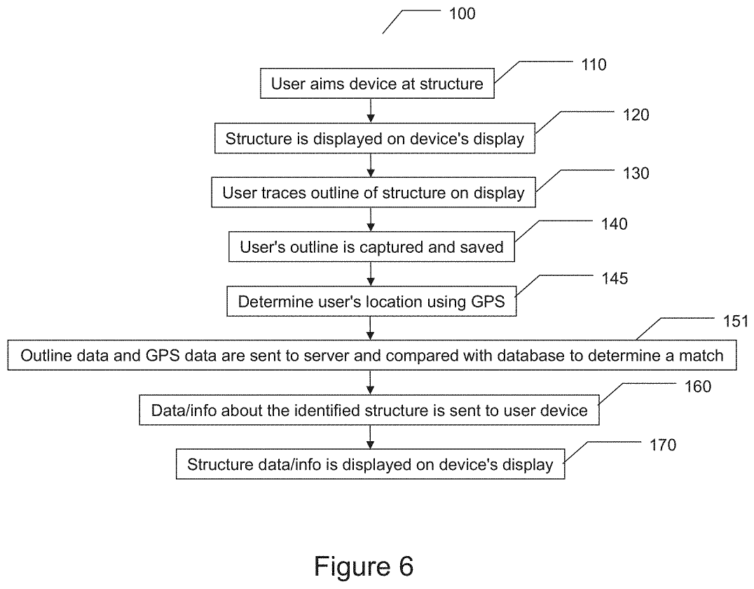

Refer to FIG. 6, which is a flowchart illustrating a method for identifying a structure according to an embodiment of the present invention.

In this embodiment the user's location is utilized to refine the accuracy of the identification of the structure.

The method 100 of the present invention begins by a user aiming their electronic user device at a structure in Step 110. In Step 120 an image of the structure is displayed on the user device's display.

Next, in Step 130, the user traces over the image of the structure to create an outline or wire-frame of the structure.

The user created outline is captured and stored on the user device in Step 140.

In Step 145 the location of the user is determined using GPS, triangulation, or other positioning techniques.

In Step 151, the outline data and the user location data are sent to the cloud server and compared with structure or architectural data stored in a database on the cloud server.

Since the user's location data is provided to the cloud server, only appropriate structures that are near the user are considered for recognition or identification. This greatly improves the accuracy of the identification but greatly speeds up the recognition process.

The cloud server sends data and information related to or associated with the identified structure to the user device in Step 160

In Step 170 the structure data and information is displayed on the display of the user device.

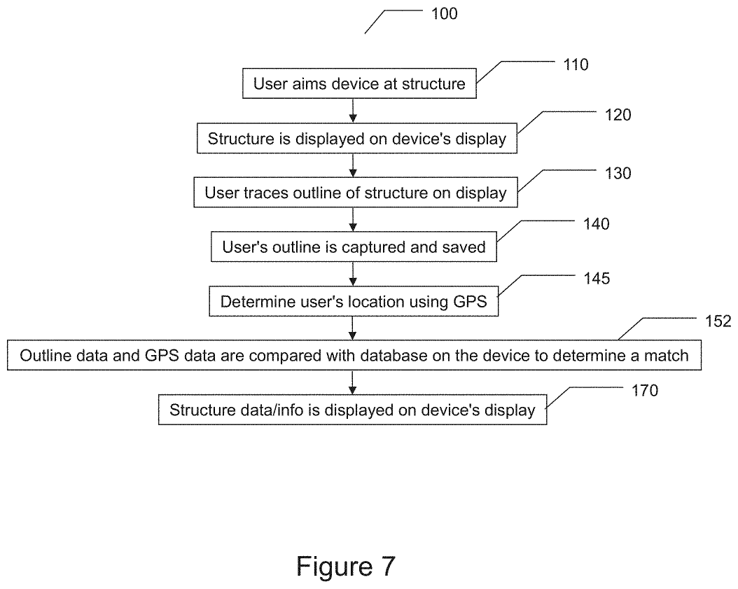

Refer to FIG. 7, which is a flowchart illustrating a method for identifying a structure by a user device and providing appropriate location and navigation information on the user device according to an embodiment of the present invention.

In this embodiment the structure or architectural database is stored on the user device. This reduces broadband, network, or roaming charges or allows the application to operate offline if needed.

Steps 110-145 are similar to the method 100 of the embodiment of FIG. 6.

In Step 152, the outline data and the user location data are utilized by the user device to compare with structure or architectural data stored in a local database on the user device.

Since the user's current location data is provided, only appropriate structures that are near the user are considered for recognition or identification. This greatly improves the accuracy of the identification but greatly speeds up the recognition process.

Then, the user device displays data and information related to or associated with the identified structure on the display of the user device in Step 170

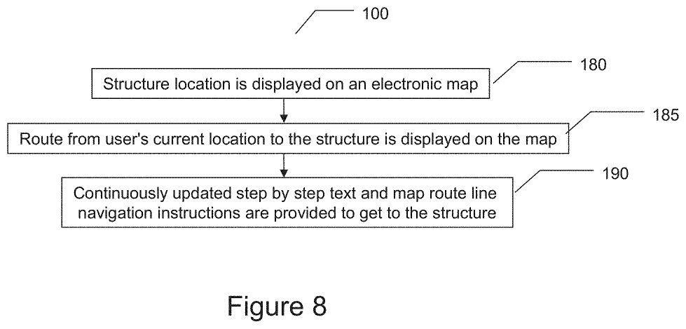

Refer to FIG. 8, which is a flowchart illustrating a method for identifying a structure by a cloud server and providing appropriate location and navigation information to a user device according to an embodiment of the present invention.

In certain situations the user is not near the structure but is within eye-shot or can see the structure off in the distance. In this embodiment the user can identify the structure and receive navigation directions on how to travel to the structure.

The method 100 continues from previous embodiments where after the structure has been recognized and identified.

In Step 180, the location of the structure is indicated and displayed on an electronic map.

Then, in Step 185, a route from the user's current location to the structure is displayed on the electronic map.

Step by step navigation instructions are provided on the user device to allow the user to travel to the structure in Step 190.

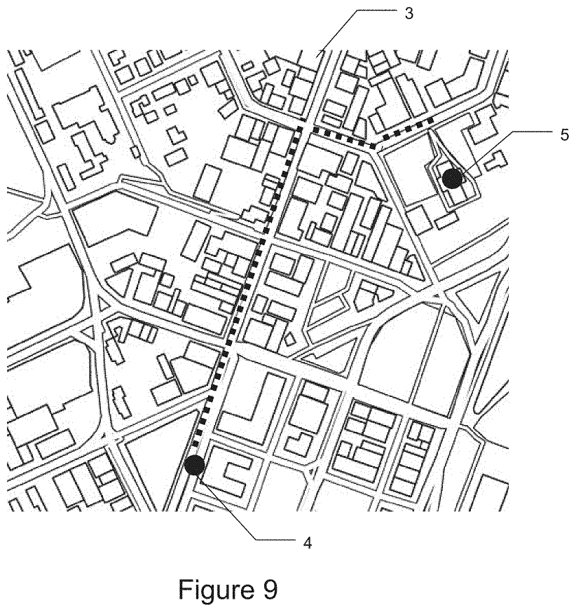

Also, refer to FIG. 9, which is a drawing illustrating a user's current location, a structure's location, and routing information on an electronic map according to an embodiment of the present invention.

As the user travels, the user's current location 4 is continually updated on the electronic map 3 until the user arrives at the structure 5.

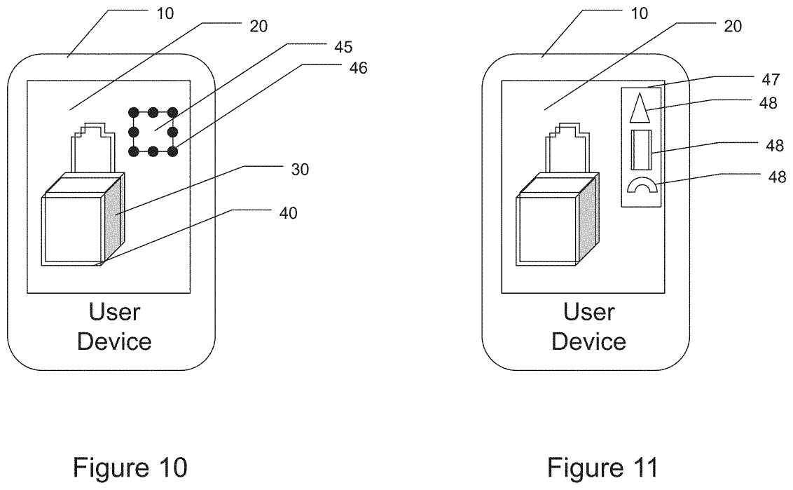

Refer to FIG. 10. In an embodiment of the present invention, elementary shape templates are provided to the user. As the user traces on the display 20 of the user device 10 to create the outline 40 of the structure 30, a suggested similar accurate template shape 45 is displayed for the user to select.

The template shape 45 comprises, for example, square, circle, triangle, hexagram, etc. The template shape 45 comprises complex structure shapes with templates for houses, buildings, statues, and monuments. The template shape 45 comprises a 2-dimensional or 3-dimensional shape.

The user simply drags and drops the template shape 45 over the image of the structure 30. The selected template shape 45 now replaces the user traced data for that section of the outline 40.

Once the template shape 45 has been positioned, the user is able to pull on nodes 46 on the template shape 45 in order to modify the size, shape, depth, perspective, or rotation of the template shape 45.

For example, the user selects a node 46 and drags to modify a square into a rectangle or make the square larger, or rotate a certain degree until the template shape 45 matches the image of the structure 30.

As the user utilizes the template shapes 45, an improved outline 40 of the image of the structure 30 is created. This allows for more accurate recognition and identification of the structure regardless of the user's artistic abilities or physical abilities.

Refer to FIG. 11. In an embodiment of the present invention a menu bar 47 or pullout menu with a plurality of the structure types 48 is provided. Pictograms of the structure types 48 is provided on the menu 47 and the user drags the appropriate pictogram of the structure type 48 onto the image of the structure 30 of interest. In this way, searching, recognition, and identification is narrowed to the scope of the selected structure type 48. For example, if a structure type 48 representing monuments is selected, only monuments are searched during recognition and identification and other types of structures are eliminated from the analyzing and searching processes.

In an embodiment of the present invention the outline tracing comprises local pre-recognition of the structure or structures details. The automatic tracing is performed locally on the user device and comprises, for example, an automatic helper or 2D-shape/3D-shape recognition, This reduces hardware resources and system requirements in order to create an automatically generated outline of the structure.

The helper of automatic local pre-recognition and shaping comprises, for example accessibility helpers and utilizing the accessibility helper application data,

This automatically generated outline is either used locally or sent to the central server in order to recognize and identify the structure.

Additionally a 3D distance measurement technology such as, for example 2-camera, SLAM or similar technology is used to determine distance between detected points of the structure. This assists in the identification of the structure as the size and shape of the structure are known.

In an embodiment of the present invention, the user points or indicates corners or sides of the structure in the viewfinder. The user device determines the distance from the user device to the structure and using the GPS position of the location of the user device, a database is referenced and the structure is identified.

In an embodiment in addition to the GPS position and distance to the structure, the digital compass direction (north, south, east, west) that the user device is aimed at is determined and the structure is identified.

If the system knows an exact position of the user and also knows the direction of the camera (viewfinder) is pointing, it can automatically suggest AR tags or wireframes of the nearest known buildings, houses and other structures. The user just taps onto an appropriate tag. The tag's names are listed in a menu or in a separate window of the application.

The user can also choose a distance to cover and list structures based on distance (for example less than 1 km, less than 5 minute walk, etc.).

Filters are also provided to eliminate unnecessary structure types, (for example “just museums” or “just churches”).

In an embodiment the user device determines the user location by GPS or triangulation. An outline of an appropriate structure in the vicinity of the current location is displayed on the device's screen. As the user scans over their surroundings, when the outline of the structure matches the viewfinder structure's image, a match is confirmed and the structure data/information is provided to the user.

In an embodiment of the present invention, skeleton image data of the structure is automatically generated by the user device from camera viewfinder lens data. This skeleton image data represents a wire-frame image of the structure. This skeleton image data creates very accurate data for low overhead comparison and data transfer.

In an embodiment of the present invention, notifications are provided to the user via the user device.

The notifications comprise information about architectural/structure events including past, present, future events which had happened, are happening, or will happen for a structure where the user is currently at or a nearby structure. The notifications comprise, for example, information about the beginning design, construction, the opening, the unveiling, or exhibitions related to a structure, architect, or designer.

The notifications further comprise notifications about nearby unique structures or landmarks to prevent a user from missing visiting an import nearby structure. The location of nearby structures is shown on an electronic map and routes and directions to a selected structure are provided.

The notifications further comprise recommendations for other similar, highly recommended, highly ranked, or unique structures within a city or user selected range or distance.

The present invention also comprises allowing users to rate a structure, add user comments, read other user's comments and ratings, and provide an overall user rating for the structure.

The notifications are received by the user device and updated to remain current. The user selects the type of notification from a menu and the appropriate notification data is displayed on the display of the user device. The user selects whether to automatically receive notifications about a structure based on current location or browse through a database of notifications and notification types.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for identifying a structure comprising:
displaying an image of a structure on a display of a user device;
tracing, by a user, an outline of the structure on the display;
capturing the outline by the user device;
sending outline data to a cloud server by the user device;
comparing the outline data with data in a database on the cloud server;
identifying the structure by the cloud server;
sending information about the structure to the user device by the cloud server; and
displaying the information about the structure on the display of the user device.

2. The method for identifying a structure of claim 1, where the image is a real-time image.

3. The method for identifying a structure of claim 1, where the image is a photograph.

4. The method for identifying a structure of claim 1, further comprising:
saving the outline data in the database and associating the outline data with the identified structure.

5. The method for identifying a structure of claim 1, further comprising:
determining a current location of the user by the user device calculating an absolute position of a GPS receiver of the user device and an absolute time of reception of satellite signals, the GPS receiver of the user devices calculating ranges that estimate the distance from the user device to a plurality of satellites;
sending current location data along with the outline data; and
using the current location data to narrow down results to possible structures.

6. The method for identifying a structure of claim 5, further comprising:
displaying location of the structure on an electronic map;
displaying a route from current location of the user to the structure on the electronic map;
providing step by step navigation instructions to the structure on the user device; and
updating current location of the user on the electronic map as the user moves.

7. A method for identifying a structure comprising:
displaying an image of a structure on a display of a user device;
tracing, by a user, an outline of the structure on the display;
capturing the outline by the user device;
comparing the outline data with data in a database stored on the user device;
identifying the structure by results of comparing by the user device; and
displaying information about the structure on the display of the user device.

8. The method for identifying a structure of claim 7, where the image is a real-time image.

9. The method for identifying a structure of claim 7, where the image is a photograph.

10. The method for identifying a structure of claim 7, further comprising:
saving the outline data in the database and associating the outline data with the identified structure.

11. The method for identifying a structure of claim 7, further comprising:
determining a current location of the user by the user device calculating an absolute position of a GPS receiver of the user device and an absolute time of reception of satellite signals, the GPS receiver of the user devices calculating ranges that estimate the distance from the user device to a plurality of satellites; and
using the current location data to narrow down results to possible structures.

12. The method for identifying a structure of claim 11, further comprising:
displaying location of the structure on an electronic map;
displaying a route from current location of the user to the structure on the electronic map;
providing step by step navigation instructions to the structure on the user device; and
updating current location of the user on the electronic map as the user moves.

13. A method for identifying a structure comprising:
displaying an image of a structure on a display of a user device;
tracing, by a user, an outline of the structure on the display;
capturing the outline by the user device;
determining a current location of the user by the user device calculating an absolute position of a GPS receiver of the user device and an absolute time of reception of satellite signals, the GPS receiver of the user devices calculating ranges that estimate the distance from the user device to a plurality of satellites;
sending outline data and current location of the user data to a cloud server by the user device;
using the current location data to narrow down results to possible structures;
comparing the outline data with data in a database;
identifying the structure by the cloud server;
saving the outline data and the current location data in the database and associating the outline data with the identified structure, and associating the current location data with the outline data to indicate perspective data;
sending information about the structure to the user device by the cloud server;
displaying the information about the structure on the display of the user device;
displaying location of the structure on an electronic map;
displaying a route from current location of the user to the structure on the electronic map;
providing step by step navigation instructions to the structure on the user device; and
updating current location of the user on the electronic map as the user moves.

14. The method for identifying a structure of claim 13, where the image is a real-time image.

15. The method for identifying a structure of claim 13, where the image is a photograph.
